(19) United States
(12) Patent Application Publication
(10) Pub. No.: US 2024/0007668 A1
(43) Pub. Date: Jan. 4, 2024

(54) IMAGE PROCESSING DEVICE AND METHOD

(71) Applicant: Sony Group Corporation, Tokyo (JP)

(72) Inventors: Tsuyoshi KATO, Kanagawa (JP); Koji YANO, Tokyo (JP)

(73) Assignee: Sony Group Corporation, Tokyo (JP)

(21) Appl. No.: 18/039,626

(22) PCT Filed: Dec. 10, 2021
(86) PCT No.: PCT/JP2021/045493

§ 371 Date: May 31, 2023

(30) Foreign Application Priority Data
Dec. 25, 2020 (JP) 2020-216904

(51) Int. Cl. H04N 19/597; G06T 17/00; H04N 13/351

(52) U.S. Cl. CPC H04N 19/597; G06T 17/00; H04N 13/351

(57) ABSTRACT

There is provided an image processing device and an image processing method capable of suppressing reduction in access speed to decoding results stored in a storage area. Coded data is decoded to generate a video frame including geometry data and a video frame including attribute data, of a point cloud expressing a three-dimensional object as a set of points. Using table information associating each of a plurality of valid points of the point cloud with each of a plurality of successive small areas in a storage area, the geometry data and the attribute data of the plurality of valid points are stored in the small area of the storage area, associated with the valid point in the table information. The present disclosure can be applied to, for example, an image processing device, an electronic device, an image processing method, a program, or the like.

### TECHNICAL FIELD

The present disclosure relates to an image processing device and an image processing method, and more particularly to an image processing device and an image processing method capable of suppressing reduction in access speed to decoding results stored in a storage area.

### BACKGROUND ART

In the related art, standardization of coding/decoding of point cloud data that expresses an object with a three-dimensional shape as a group of points has been advanced by the Moving Picture Experts Group (MPEG) (see NPL 1, for example).

A method of projecting geometry data and attribute data of a point cloud to a two-dimensional plane for each small area, arranging an image (patch) projected to the two-dimensional plane within a frame image, and coding the frame image by a coding method for a two-dimensional image (hereinafter, also referred to as a video-based approach) has been proposed (see NPL 2 to NPL 4, for example).

In recent years, various attempts have been made as coding/decoding techniques for this point cloud data. For example, a method of implementing part of such point cloud data decoding processing on a GPU (Graphics Processing Unit) has been considered (see, for example, NPL 5). By doing so, it is possible to speed up the decoding processing. In addition, in order to improve convenience, development of a software library of point cloud data is underway.

For example, the point cloud decoder is made into a software library, and the decoding result is held in memory. By doing so, an application that executes rendering or the like can obtain the decoding result by accessing the memory at arbitrary timing.

### CITATION LIST

### Non Patent Literature

[NPL 1]
“Information technology—MPEG-I (Coded Representation of Immersive Media)—Part 9: Geometry-based Point Cloud Compression”, ISO/IEC 23090-9: 2019(E)

[NPL 2]
Tim Golla and Reinhard Klein, “Real-time Point Cloud Compression”, IEEE, 2015

[NPL 3]
K. Mammou, “Video-based and Hierarchical Approaches Point Cloud Compression”, MPEG m41649, October 2017

[NPL 4]
K. Mammou, “PCC Test Model Category 2 v0”, N17248 MPEG output document, October 2017

[NPL 5]
Vladyslav Zakharchenko, “[VPCC] [Software] Open-source initiative for dynamic point cloud content delivery”, ISO/IEC JTC1/SC29/WG11 MPEG2020/m53349, April 2020, Alpbach, Austria

### SUMMARY

### Technical Problem

However, in the video-based approach described above, not only valid points but also invalid data are output as the result of the decoding processing. Therefore, it has been difficult to store valid point information in a successive area of the storage area of the memory. Therefore, the application cannot access the memory sequentially, which may reduce the access speed.

In view of such situations, the present disclosure is directed to suppress a decrease in access speed to decoding results stored in a storage area.

### Solution to Problem

An image processing device according to one aspect of the present technology is an image processing device including: a video frame decoding unit that decodes coded data to generate a video frame including geometry data projected onto a two-dimensional plane and a video frame including attribute data projected onto a two-dimensional plane, of a point cloud expressing a three-dimensional object as a set of points; and a control unit that uses table information associating each of a plurality of valid points of the point cloud with each of a plurality of successive small areas in a storage area to store the geometry data and the attribute data of the plurality of valid points generated from the video frames generated by the video frame decoding unit in the small area of the storage area, associated with the valid point in the table information.

An image processing method according to one aspect of the present technology is an image processing method including: decoding coded data to generate a video frame including geometry data projected onto a two-dimensional plane and a video frame including attribute data projected onto a two-dimensional plane, of a point cloud expressing a three-dimensional object as a set of points; and using table information associating each of a plurality of valid points of the point cloud with each of a plurality of successive small areas in a storage area, storing the geometry data and the attribute data of the plurality of valid points generated from the generated video frames in the small area of the storage area, associated with the valid point in the table information.

An image processing device according to another aspect of the present technology is an image processing device including: a video frame coding unit that codes a video frame including geometry data projected onto a two-dimensional plane and a video frame including attribute data projected onto a two-dimensional plane, of a point cloud expressing a three-dimensional object as a set of points to generate coded data; a generation unit that generates metadata including information about the number of valid points of the point cloud; and a multiplexing unit that multiplexes the coded data generated by the video frame coding unit and the metadata generated by the generation unit.

An image processing method according to another aspect of the present technology is an image processing method including: coding a video frame including geometry data projected onto a two-dimensional plane and a video frame including attribute data projected onto a two-dimensional plane, of a point cloud expressing a three-dimensional object as a set of points to generate coded data; generating metadata including information about the number of valid points of the point cloud; and multiplexing the generated coded data and metadata.

In the image processing device and an image processing method of one aspect of the present technology, coded data is decoded to generate a video frame including geometry data projected onto a two-dimensional plane and a video frame including attribute data projected onto a two-dimensional plane, of a point cloud expressing a three-dimensional object as a set of points; and using table information associating each of a plurality of valid points of the point cloud with each of a plurality of successive small areas in a storage area, the geometry data and the attribute data of the plurality of valid points generated from the generated video frames are stored in the small area of the storage area, associated with the valid point in the table information.

In the image processing device and an image processing method of another aspect of the present technology, a video frame including geometry data projected onto a two-dimensional plane and a video frame including attribute data projected onto a two-dimensional plane, of a point cloud expressing a three-dimensional object as a set of points are coded to generate coded data; metadata including information about the number of valid points of the point cloud is generated; and the generated coded data and metadata are multiplexed.

### BRIEF DESCRIPTION OF DRAWINGS

FIG. 1 is a diagram for explaining a video-based approach.

FIG. 2 is a diagram for explaining a storage example of decoding results.

FIG. 3 is a diagram for explaining a storage example of decoding results.

FIG. 4 is a diagram for explaining a storage example of decoding results using LUTs.

FIG. 5 is a diagram for explaining a LUT.

FIG. 6 is a block diagram illustrating an example of major components of a coding device.

FIG. 7 is a diagram for explaining metadata.

FIG. 8 is a flowchart for explaining an example of an example of coding processing.

FIG. 9 is a block diagram illustrating an example of major components of a decoding device.

FIG. 10 is a diagram illustrating an example of syntax.

FIG. 11 is a diagram for explaining processing executed by a LUT generation unit.

FIG. 12 is a diagram for explaining processing executed by the LUT generation unit.

FIG. 13 is a flowchart for explaining an example of a flow of decoding processing.

FIG. 14 is a block diagram illustrating an example of major components of a coding device.

FIG. 15 is a flowchart for explaining an example of a flow of coding processing.

FIG. 16 is a block diagram illustrating an example of major components of a decoding device.

FIG. 17 is a flowchart illustrating an example of a flow of decoding processing.

FIG. 18 is a block diagram illustrating an example of major components of a coding device.

FIG. 19 is a flowchart for explaining an example of a flow of coding processing.

FIG. 20 is a block diagram illustrating an example of major components of a decoding device.

FIG. 21 is a flowchart for explaining an example of a flow of decoding processing.

FIG. 22 is a block diagram illustrating an example of major components of a computer.

### DESCRIPTION OF EMBODIMENTS

Hereinafter, modes for carrying out the present disclosure (hereinafter referred as embodiments) will be described. The descriptions will be given in the following order.

1. Memory storage control based on LUT

2. First Embodiment (Coding Device)

3. Second Embodiment (Decoding Device)

4. Third Embodiment (Coding Device/Decoding Device)

5. Fourth Embodiment (Coding Device/Decoding Device)

6. Application examples

7. Supplement

### 1. Memory Storage Control Based on LUT

<Documents that Support Technical Content and Terms>

The scope disclosed in the present technology is not limited to the content described in the embodiments and also includes the content described in the following NPL and the like that were known at the time of filing, the content of other literature referred to in the following NPL, and the like.
[NPL 1] (described above)
[NPL 2] (described above)
[NPL 3] (described above)
[NPL 4] (described above)
[NPL 5] (described above)

In other words, the content described in the above NPL, content of other literature referred to in the above NPL, and the like are also grounds for determining support requirements.

<Point Cloud>

In the related art, 3D data such as a point cloud expressing a three-dimensional structure by point position information, attribute information, or the like is present.

In a case of a point cloud, for example, a stereoscopic structure (an object with a three-dimensional shape) is expressed as a group of multiple points. The point cloud is constituted by position information of each point (also referred to as a geometry) and attribute information (also referred to as an attribute). The attribute can include arbitrary information. For example, color information, reflectance information, normal line information, and the like of each point may be included in the attribute. In this manner, according to the point cloud, a data structure is relatively simple, and it is possible to express an arbitrary stereoscopic structure with sufficient accuracy by using a sufficiently large number of points.

<Outline of Video-Based Approach>

In a video-based approach, a geometry and an attribute of such a point cloud are projected to a two-dimensional plane for each small area (connection component).

In the present disclosure, the small area may be referred to as a partial area.

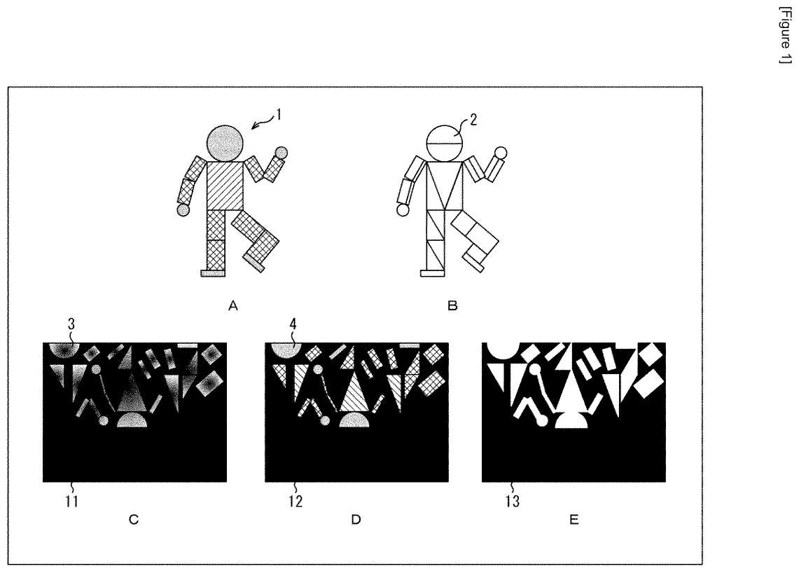

An image in which the geometry and the attribute are projected to the two-dimensional plane will also be referred to as a projection image. The projection image for each small area (partial area) will be referred to as a patch. For example, object 1 (3D data) in FIG. 1A is decomposed into patches 2 (2D data) as illustrated in FIG. 1B. For geometry patches, each pixel value indicates the position information of the point. However, in that case, the position information of a point in the projection image (patch) of the geometry is expressed as position information (depth value (Depth)) in the vertical direction (depth direction) with respect to the projection plane.

Additionally, each patch generated in this manner is arranged in a frame image of a video sequence (also referred to as a video frame). A frame image in which patches of a geometry are arranged will also be referred to as a geometry video frame. A frame image in which patches of an attribute are arranged will also be referred to as an attribute video frame. For example, from object 1 of FIG. 1A, a geometry video frame 11 in which a geometry patch 3 as illustrated in FIG. 1C is arranged and an attribute video frame 12 in which an attribute patch 4 as illustrated in FIG. 1D is arranged is generated. For example, each pixel value of a geometry video frame 11 indicates the aforementioned depth value.

Then, these video frames are coded by a coding method for a two-dimensional image, such as Advanced Video Coding (AVC) or High Efficiency Video Coding (HEVC), for example. In other words, point cloud data that is 3D data expressing a three-dimensional structure can be coded using a codec for a two-dimensional image.

<Occupancy Map>

Note that in the case of such a video-based approach, it is also possible to use an occupancy map. The occupancy map is map information indicating presence/absence of a projection image (patch) for each of N×N pixels of a geometry video frame or an attribute video frame. For example, the occupancy map indicates, by a value “1”, an area (N×N pixels) where patches are present and indicates, by a value “0”, an area (N×N pixels) where no patches are present of the geometry video frame or the attribute video frame.

Such an occupancy map is coded as data that is different from the geometry video frame or the attribute video frame and is then transmitted to a decoding side.

Since a decoder can recognize whether patches are present in the area with reference to the occupancy map, it is possible to suppress influences of noise and the like generated by coding/decoding and to more accurately reconstruct 3D data. Even if a depth value changes due to coding/decoding, for example, the decoder can ignore a depth value (not process it as position information of the 3D data) in the area where no patches are present with reference to the occupancy map.

For example, for the geometry video frame 11 and the attribute video frame 12, an occupancy map 13 as illustrated in FIG. 1E may be generated. In the occupancy map 13, the white portion indicates the value “1” and the black portion indicates the value “0”.

Note that the occupancy map can also be transmitted as a video frame similarly to the geometry video frame, the attribute video frame, and the like.

<Auxiliary Patch Information>

Furthermore, in the case of the video-based approach, information regarding patches (also referred to as auxiliary patch information) is transmitted as metadata.

<Moving Image>

Note that in the following description, (an object) of a point cloud can change in a time direction like a moving image of a two-dimensional image. In other words, geometry data and attribute data are assumed to include a concept of the time direction and are assumed to be data sampled for each predetermined period of time like a moving image of a two-dimensional image. Note that data at each sampling clock time will be referred to as a frame like a video frame of a two-dimensional image. In other words, each item of point cloud data (geometry data and attribute data) is assumed to be constituted by a plurality of frames like a moving image of a two-dimensional image. In the present disclosure, the frames of the point cloud will also be referred to as point cloud frames. In the case of the video-based approach, it is possible to highly efficiently code even such a point cloud of a moving image (a plurality of frames) using a moving image coding scheme by obtaining a video sequence through conversion of each point cloud frame into a video frame.

<Software Library>

In recent years, various attempts have been made as coding/decoding techniques for this point cloud data. For example, as described in NPL 5, a method of implementing part of such point cloud data decoding processing on a GPU (Graphics Processing Unit) has been considered. By doing so, it is possible to speed up the decoding processing. In addition, in order to improve convenience, development of a software library of point cloud data is underway.

For example, the point cloud decoder is made into a software library, and the decoding result is held in memory. By doing so, an application that executes rendering or the like can obtain the decoding result by accessing the memory at arbitrary timing.

However, in the video-based approach described above, not only valid points but also invalid data are output as the result of the decoding processing. Therefore, it has been difficult to store valid point information in successive areas of the storage area of the memory.

### Write Example 1

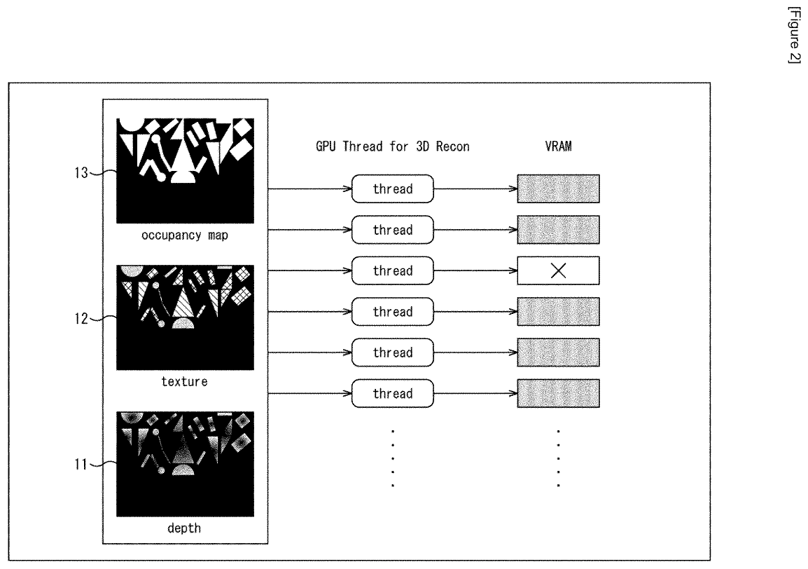

For example, when reconstructing a point cloud from video frames of geometry, attributes, occupancy maps, and the like, the data of each video frame is split and processed using multiple threads of the GPU, as illustrated in FIG. 2. Each thread outputs a processing result to a predetermined position in a memory (VRAM (Video Random Access Memory)). However, no decoding result is output for invalid areas in the occupancy map. Therefore, the decoding result is not stored in the memory area corresponding to the thread. In other words, the decoding result (that is, valid point information) is not stored in a successive area, but is stored in an intermittent area. Therefore, for example, when accessing the decoding results stored in its memory, an application could not access the decoding results sequentially. Therefore, there is a possibility that the speed of access to the decoding results will be reduced. In addition, there is a possibility that the storage capacity required for storing the decoding results may increase due to the formation of an empty area in which the decoding results are not stored.

### Write Example 2

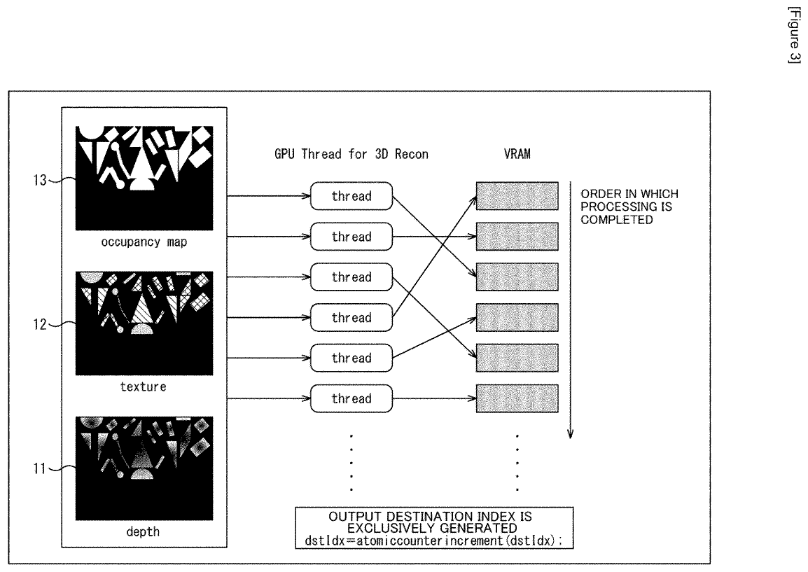

For example, as illustrated in FIG. 3, a method of writing the decoding results output from each thread in the order of output in a successive area of the memory area is conceivable. In other words, in this case, each thread sequentially outputs the results to the exclusively generated writing positions in the order in which processing is completed. However, in the case of this method, exclusive control is required as data write control to the memory. Therefore, there was a possibility that it would be difficult to realize parallel execution of processing.

In addition, since the output order of decoding results from each thread changes each time writing is performed, complicated processing such as managing the order and using it for write control and read control is required. This may increase the decoding load.

<Write Control Using LUT>

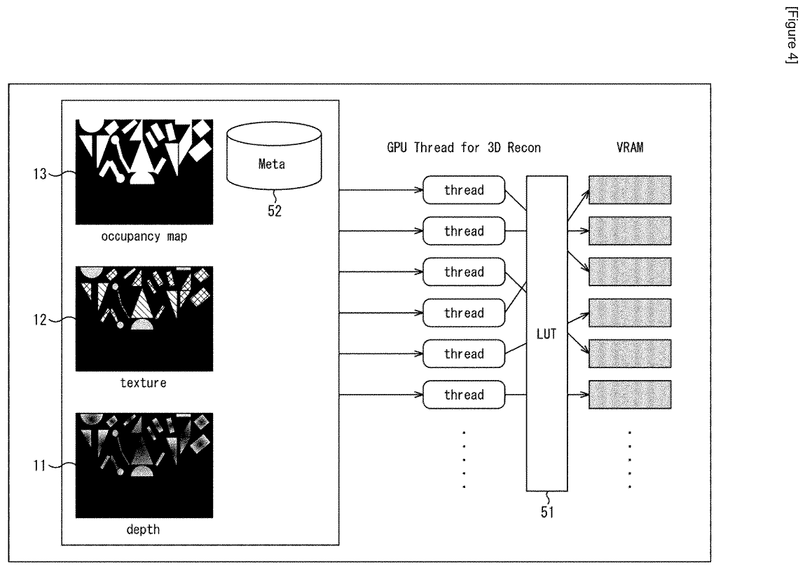

Therefore, as in the example illustrated in FIG. 4, a LUT (Lookup table) that designates an area to write the decoding result is used to control the storage position of the decoding result. In other words, as illustrated in FIG. 4, each thread of the GPU outputs the decoding result to the writing position (address) of a VRAM obtained by a LUT 51.

The LUT 51 includes information that specifies (identifies) a thread that processes a valid point. In other words, the LUT 51 indicates in which thread of the GPU thread group a valid point is processed. Metadata 52 is also supplied from the coding-side device together with video frames and the like. This metadata includes information about the number of valid points.

By using the LUT 51 and the metadata 52, it is possible to derive a small area (address) of the memory (storage area) for storing the decoding result output from the thread that processes the valid point. In addition, a correspondence relationship between threads and small areas can be established so that the decoding results output from threads that process valid points are stored in successive small areas.

In other words, by controlling writing to the VRAM using the LUT 51 and the metadata 52, it is possible to output the decoding results for valid points output from the thread to successive small areas of the storage area.

For example, an information processing method includes: decoding coded data to generate a video frame including geometry data projected onto a two-dimensional plane and a video frame including attribute data projected onto a two-dimensional plane, of a point cloud expressing a three-dimensional object as a set of points; and using table information associating each of a plurality of valid points of the point cloud with each of a plurality of successive small areas in a storage area, storing the geometry data and the attribute data of the plurality of valid points generated from the generated video frames in the small area of the storage area, associated with the valid point in the table information.

For example, an information processing device includes: a video frame decoding unit that decodes coded data to generate a video frame including geometry data projected onto a two-dimensional plane and a video frame including attribute data projected onto a two-dimensional plane, of a point cloud expressing a three-dimensional object as a set of points; and a control unit that uses table information associating each of a plurality of valid points of the point cloud with each of a plurality of successive small areas in a storage area to store the geometry data and the attribute data of the plurality of valid points generated from the video frames generated by the video frame decoding unit in the small area of the storage area, associated with the valid point in the table information.

By doing so, it is possible to more easily store the decoding results of valid points in successive small areas of the storage area of a memory. Therefore, it is possible to suppress a decrease in access speed to the decoding result stored in the storage area.

Note that this LUT 51 may be generated for each of the first partial areas.

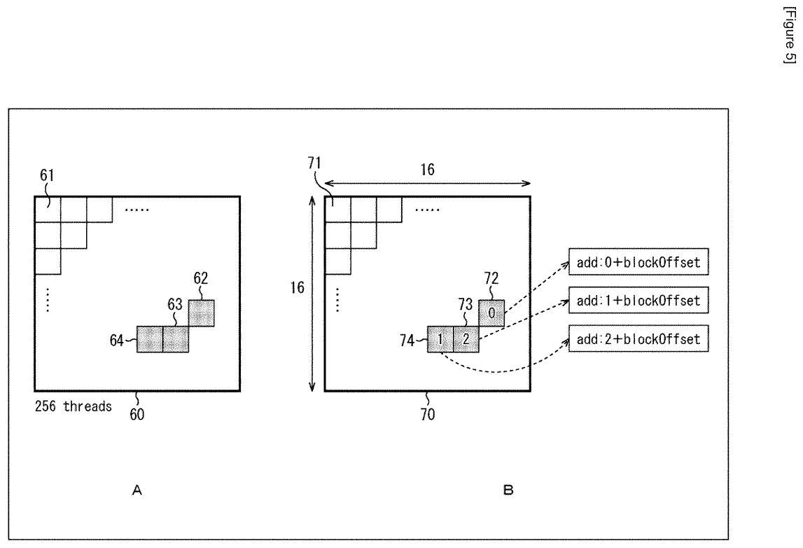

For example, as illustrated in FIG. 5A, the area processed using 256 threads of the GPU may be one block (first partial area). In each thread, data of one point may be processed, or data of a plurality of points may be processed. Each square illustrated within a block 60 illustrated in FIG. 5A represents one thread. That is, the block 60 includes 256 threads 61. It is assumed that valid point data is processed in three threads 62 to 64 illustrated in gray. That is, the decoding results are output from these threads to a memory. In other words, the other threads 61 process invalid data. In other words, these threads 61 do not output decoding results.

A LUT 70 corresponding to such a block 60 is generated (FIG. 5B). The LUT 70 has an element 71 corresponding to each thread. That is, the LUT 70 has 256 elements 71. An element 72 corresponding to the thread 62 of the block 60, an element 73 corresponding to the thread 63 of the block 60, and an element 74 corresponding to the thread 64 of the block 60 are set with identification information (0 to 2) (identification information for identifying elements corresponding to the threads that process valid point data in the LUT 70) for identifying the threads that process the valid point data in the block 60. This identification information is not set for other elements 71 corresponding to other threads 61 in which invalid data is processed.

As illustrated in FIG. 5B, using this identification information and a block offset, which is the offset assigned to the block 60, the storage destination address of the decoding result output from each of the threads 62 to 64 can be derived. For example, by adding the block offset to the identification information (0 to 2) of the elements 72 to 74, it is possible to derive the storage destination addresses of the decoding results output from the threads 62 to 64, respectively.

Note that this calculation result may be stored in the LUT 70. That is, each element of the LUT 70 may have a storage destination address for the decoding result.

### 2. First Embodiment

<Coding Device>

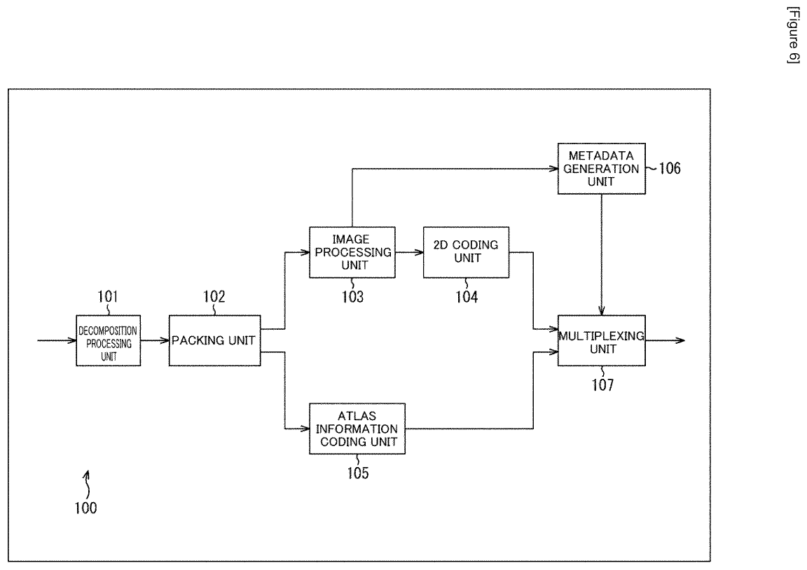

FIG. 6 is a block diagram illustrating an example of a configuration of a coding device according to an embodiment of an image processing device to which the present technology is applied. A coding device 100 illustrated in FIG. 6 is a device that performs coding by a coding method for a two-dimensional image by applying a video-based approach and using point cloud data as a video frame.

FIG. 6 illustrates principal components such as processing units and data flows, and FIG. 6 does not illustrate all components. That is, processing units that are not illustrated in FIG. 6 as blocks and processing and data flows that are not illustrated in FIG. 6 as arrows and the like may be present in the coding device 100.

As illustrated in FIG. 6, the coding device 100 includes a decomposition processing unit 101, a packing unit 102, an image processing unit 103, a 2D coding unit 104, an atlas information coding unit 105, a metadata generation unit 106, and a multiplexing unit 107.

The decomposition processing unit 101 performs processing related to decomposition of geometry data and attribute data. For example, the decomposition processing unit 101 acquires a point cloud data input to the coding device 100. The decomposition processing unit 101 decomposes the acquired point cloud data into patches and generates a geometry patch and an attribute patch. Then, the decomposition processing unit 101 supplies the patches to the packing unit 102.

The packing unit 102 performs processing regarding packing. For example, the packing unit 102 acquires geometry and attribute patches supplied from the decomposition processing unit 101. Then, the packing unit 102 packs the acquired geometry patch in a video frame and generates a geometry video frame.

The packing unit 102 packs the acquired attribute patches in a video frame of each attribute and generates an attribute video frame. The packing unit 102 supplies the generated geometry video frame and attribute video frame to the image processing unit 103.

The packing unit 102 also generates atlas information (atlas), which is information for reconstructing a point cloud (3D data) from patches (2D data), and supplies it to the atlas information coding unit 105.

The image processing unit 103 acquires the geometry video frame and attribute video frame supplied from the packing unit 102. The image processing unit 103 performs padding processing for filling gaps between patches on those video frames. The image processing unit 103 supplies the padded geometry video frame and attribute video frame to the 2D coding unit 104.

The image processing unit 103 also generates an occupancy map based on the geometry video frames. The image processing unit 103 supplies the generated occupancy map to the 2D coding unit 104 as a video frame. The image processing unit 103 also supplies the occupancy map to the metadata generation unit 106.

The 2D coding unit 104 acquires the geometry video frame, attribute video frame, and occupancy map supplied from the image processing unit 103. The 2D coding unit 104 codes the frames and the map to generate coded data. That is, the 2D coding unit 104 codes a video frame including geometry data projected onto a two-dimensional plane and a video frame including attribute data projected onto a two-dimensional plane to generate coded data. The 2D coding unit 104 also supplies the coded data of the geometry video frame, the coded data of the attribute video frame, and the coded data of the occupancy map to the multiplexing unit 107.

The atlas information coding unit 105 acquires the atlas information supplied from the packing unit 102. The atlas information coding unit 105 codes the atlas information to generate coded data. The atlas information coding unit 105 supplies the coded data of the atlas information to the multiplexing unit 107.

The metadata generation unit 106 acquires the occupancy map supplied from the image processing unit 103. The metadata generation unit 106 generates metadata including information about the number of valid points in the point cloud based on the occupancy map.

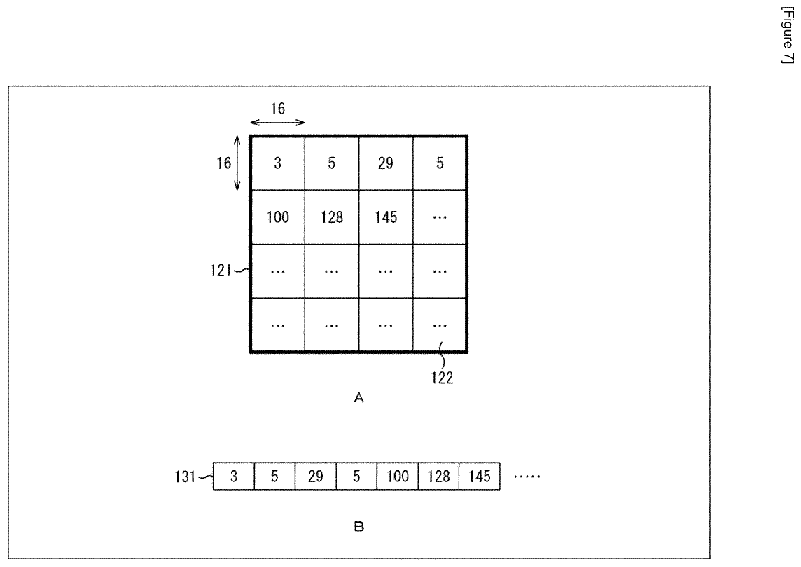

For example, in FIG. 7A, an occupancy map 121 surrounded by a thick line is divided (blocked) into areas processed by 256 threads. The number of valid points is counted for each block 122. The number within each block 122 indicates the number of valid points included in that block 122.

Since the occupancy map 121 indicates where patches exist, the metadata generation unit 106 can determine the number of valid points based on that information. The metadata generation unit 106 counts the number of valid points in each block, aligns the count values (number of valid points) in series as illustrated in FIG. 7B, and generates metadata 131. That is, the metadata generation unit 106 generates metadata 131 indicating the number of valid points for each block (first partial area). The metadata generation unit 106 generates this metadata based on the occupancy map. That is, the metadata generation unit 106 generates this metadata 131 based on the video frames coded by the 2D coding unit 104.

The size of this block 122 is arbitrary. For example, by setting the size according to the processing unit of the GPU, it is possible to more efficiently control the writing of the decoding result to the memory. That is, an increase in load can be suppressed.

The metadata generation unit 106 performs lossless coding (lossless compression) on the metadata 131. That is, the metadata generation unit 106 generates coded data of metadata. The metadata generation unit 106 supplies the coded data of the metadata to the multiplexing unit 107.

The multiplexing unit 107 acquires coded data for each of the geometry video frame, the attribute video frame, and the occupancy map supplied from the 2D coding unit 104. The multiplexing unit 107 also acquires coded data of the atlas information supplied from the atlas information coding unit 105. Furthermore, the multiplexing unit 107 acquires coded data of the metadata supplied from the metadata generation unit 106.

The multiplexing unit 107 multiplexes the coded data to generate a bitstream. That is, the multiplexing unit 107 multiplexes the coded data generated by the 2D coding unit 104 and the metadata (encoded data thereof) generated by the metadata generation unit 106. The multiplexing unit 107 outputs the generated bitstream to the outside of the coding device 100.

Note that these processing units (the decomposition processing unit 101 to the multiplexing unit 107) have arbitrary configurations. For example, each processing unit may be configured by a logical circuit that realizes the aforementioned processing. Each processing unit may have, for example, a central processing unit (CPU), a read only memory (ROM), a random access memory (RAM), and the like and realize the aforementioned processing by executing a program using them. It goes without saying that each processing unit may have both the aforementioned configurations, realize parts of the aforementioned processing according to a logic circuit, and realize the other part of the processing by executing a program. The processing units may have independent configurations, for example, some processing units may realize parts of the aforementioned processing according to a logic circuit, some other processing units may realize the aforementioned processing by executing a program, and some other processing units may realize the aforementioned processing according to both a logic circuit and execution of a program.

With the above-described configuration, the coding device 100 can supply metadata including information about the number of valid points in the point cloud to the decoding-side device. As a result, the decoding-side device can more easily control the writing of the decoding result to the memory. The decoding-side device can store the decoding results of valid points in successive small areas of the storage area based on the metadata. As a result, it is possible to suppress a decrease in access speed to the decoding result stored in the storage area.

<Flow of Coding Processing>

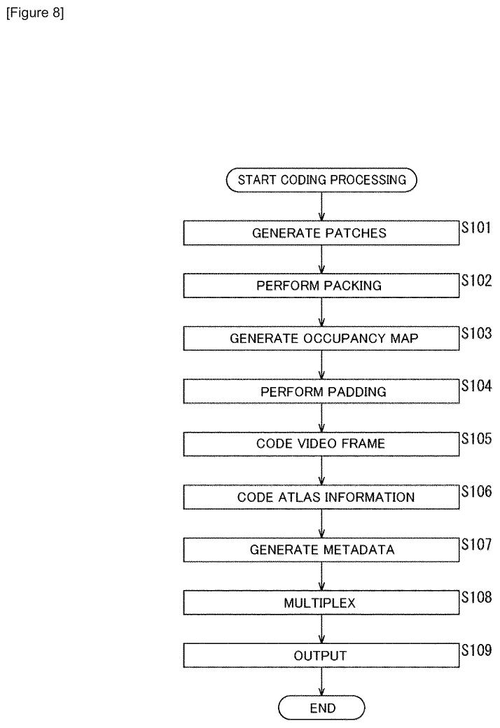

An example of a flow of coding processing executed by the coding device 100 will be described with reference to the flowchart in FIG. 8.

When the coding processing is started, the decomposition processing unit 101 of the coding device 100 decomposes the point cloud into patches to generate geometry and attribute patches in step S101.

In step S102, the packing unit 102 packs the patches generated in step S101 into a video frame. For example, the packing unit 102 packs the geometry patch and generates a geometry video frame. The packing unit 102 packs attribute patches and generates an attribute video frame.

In step S103, the image processing unit 103 generates an occupancy map based on the geometry video frame.

In step S104, the image processing unit 103 performs padding processing on the geometry video frame and the attribute video frame.

In step S105, the 2D coding unit 104 codes the geometry video frame and the attribute video frame obtained by the processing of step S102 using a two-dimensional image coding method. That is, the 2D coding unit 104 codes a video frame including geometry data projected onto a two-dimensional plane and a video frame including attribute data projected onto a two-dimensional plane to generate coded data.

In step S106, the atlas information coding unit 105 codes the atlas information.

In step S107, the metadata generation unit 106 generates and codes metadata including information about the number of valid points in the point cloud.

In step S108, the multiplexing unit 107 multiplexes the coded data of the geometry video frame, attribute video frame, occupancy map, atlas information, and metadata to generate a bitstream.

In step S109, the multiplexing unit 107 outputs the generated bitstream. When processing of step S109 ends, coding processing ends.

By executing the processing of each step in this manner, the coding device 100 can supply metadata including information about the number of valid points in the point cloud to the decoding-side device. As a result, the decoding-side device can more easily control the writing of the decoding result to the memory. The decoding-side device can store the decoding results of valid points in successive small areas of the storage area based on the metadata. As a result, it is possible to suppress a decrease in access speed to the decoding result stored in the storage area.

### 3. Second Embodiment

<Decoding Device>

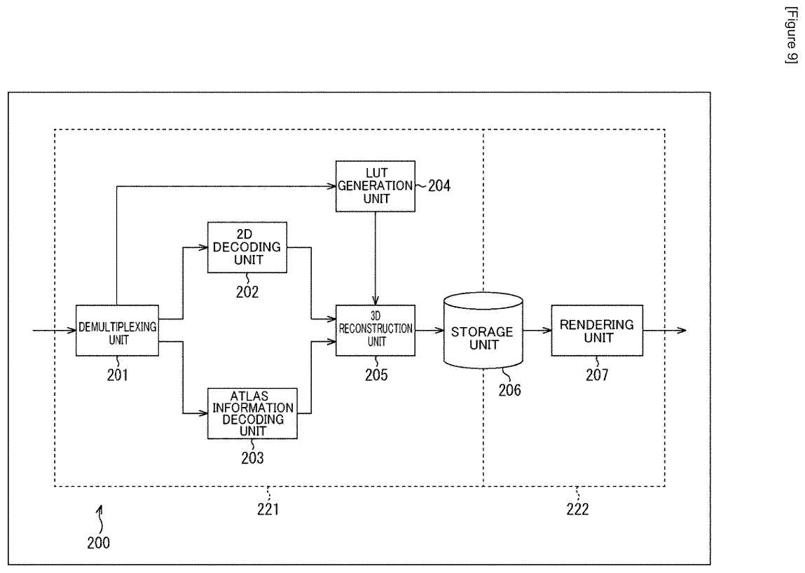

FIG. 9 is a block diagram illustrating an example of a configuration of a decoding device according to an aspect of an image processing device to which the present technology is applied. A decoding device 200 illustrated in FIG. 9 is a device that applies a video-based approach, decodes coded data obtained by coding a point cloud data as a video frame by a coding method for a two-dimensional image by a decoding method for a two-dimensional image, and generates (reconstructs) the point cloud.

FIG. 9 illustrates principal components such as processing units and data flows, and FIG. 9 does not illustrate all components. That is, processing units that are not illustrated in FIG. 9 as blocks and processing and data flows that are not illustrated in FIG. 9 as arrows and the like may be present in the decoding device 200.

As illustrated in FIG. 9, the decoding device 200 includes a demultiplexing unit 201, a 2D decoding unit 202, an atlas information decoding unit 203, a LUT generation unit 204, a 3D reconstruction unit 205, a storage unit 206, and a rendering unit 207.

The demultiplexing unit 201 acquires a bitstream input to the decoding device 200. The bitstream is generated by the coding device 100 coding point cloud data, for example. The demultiplexing unit 201 demultiplexes this bitstream.

The demultiplexing unit 201 extracts the coded data of the geometry video frame, the coded data of the attribute video frame, and the coded data of the occupancy map by demultiplexing the bitstream. The demultiplexing unit 201 supplies the coded data to the 2D decoding unit 202. The demultiplexing unit 201 extracts the coded data of the atlas information by demultiplexing the bitstream. The demultiplexing unit 201 supplies the coded data of the atlas information to the atlas information decoding unit 203. The demultiplexing unit 201 extracts the coded data of the metadata by demultiplexing the bitstream. That is, the demultiplexing unit 201 acquires metadata including information about the number of valid points. The demultiplexing unit 201 supplies the coded data of the metadata and the coded data of the occupancy map to the LUT generation unit 204.

The 2D decoding unit 202 acquires the coded data of the geometry video frame, the coded data of the attribute video frame, and the coded data of the occupancy map supplied from the demultiplexing unit 201. The 2D decoding unit 202 decodes the coded data to generate the geometry video frame, the attribute video frame, and the occupancy map. The 2D decoding unit 202 supplies the frames and the map to the 3D reconstruction unit 205.

The atlas information decoding unit 203 acquires the coded data of the atlas information supplied from the demultiplexing unit 201. The atlas information decoding unit 203 decodes the coded data to generate atlas information. The atlas information decoding unit 203 supplies the generated atlas information to the 3D reconstruction unit 205.

The LUT generation unit 204 acquires the coded data of the metadata supplied from the demultiplexing unit 201. The LUT generation unit 204 losslessly decodes the coded data to generate metadata including information about the number of valid points in the point cloud. This metadata indicates, for example, the number of valid points for each block (first partial area), as described above.

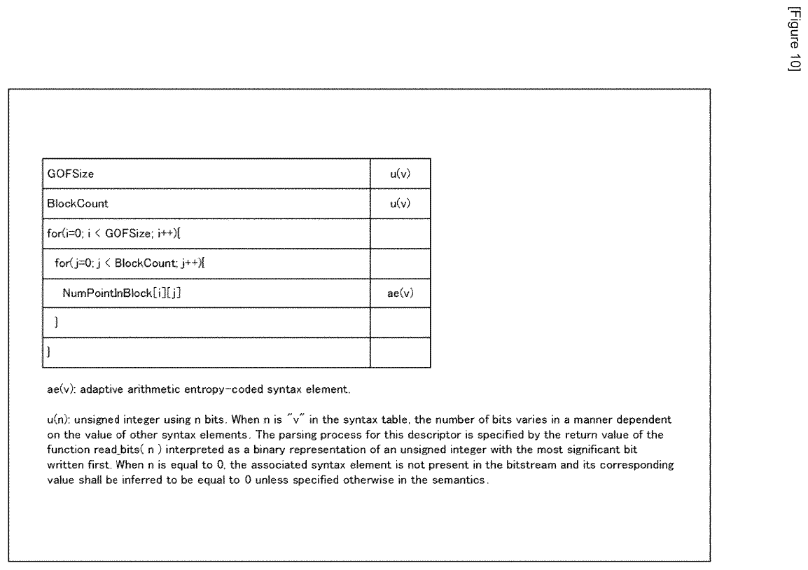

That is, information indicating how many valid points exist in each block is signaled from the coding-side device. An example of syntax in that case is illustrated in FIG. 10.

The LUT generation unit 204 acquires the coded data of the occupancy map supplied from the demultiplexing unit 201. The LUT generation unit 204 decodes the coded data to generate the occupancy map.

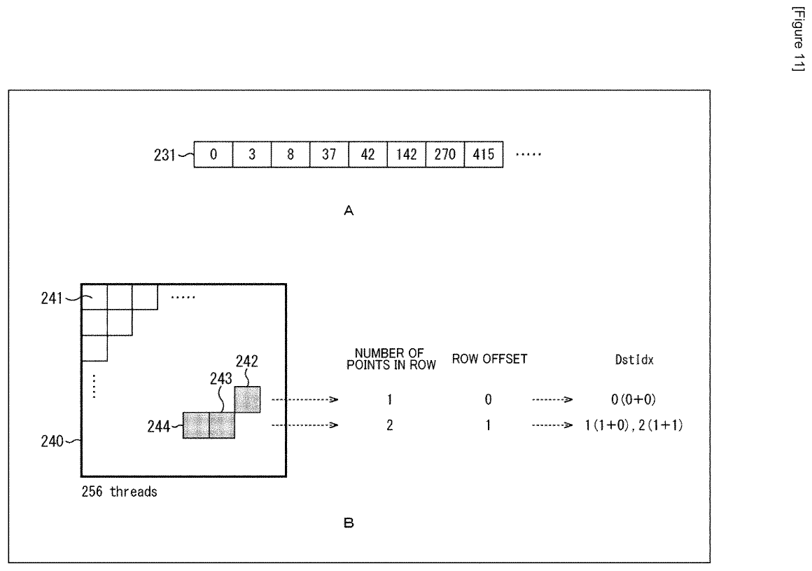

The LUT generation unit 204 derives a block offset, which is an offset for each block, from the metadata. For example, the LUT generation unit 204 derives the block offset 231 illustrated in FIG. 11A by accumulating the values of the metadata 131 illustrated in FIG. 7B. That is, the LUT generation unit 204 can derive the offset of the first partial area based on information indicating the number of valid points for each of the first partial areas included in the metadata.

The LUT generation unit 204 generates a LUT using the generated metadata and occupancy map. For example, the LUT generation unit 204 generates a LUT 240 for each block (first partial area), as illustrated in FIG. 11B. This LUT 240 is table information similar to the LUT 70 in FIG. 5B, and is composed of 256 elements 241 corresponding to threads.

An element 242 corresponding to the thread 62 of block 60, an element 243 corresponding to the thread 63 of the block 60, and an element 244 corresponding to the thread 64 of the block 60, illustrated in gray, are set with identification information (identification information for identifying elements corresponding to the threads that process valid point data in the LUT 240) for identifying threads that process valid point data in the block 60. This identification information is not set in other elements 241 corresponding to other threads 61 in which invalid data is processed.

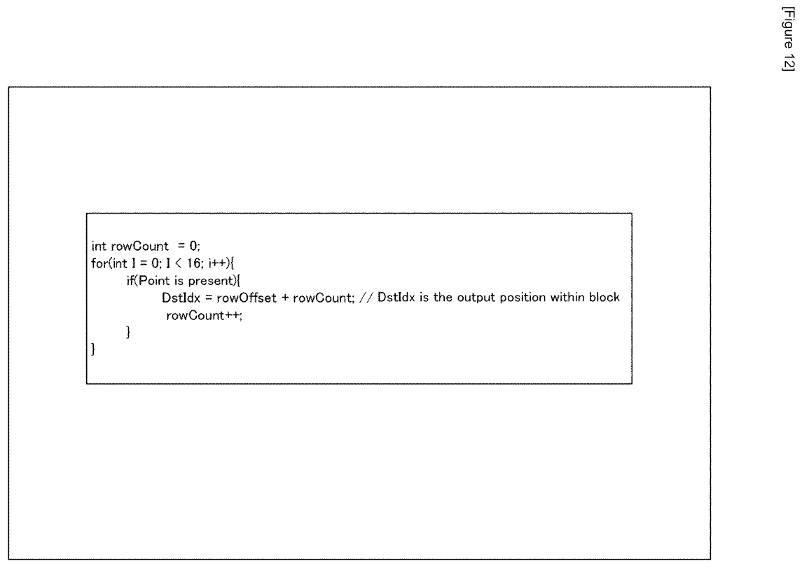

The LUT generation unit 204 counts the number of points in each row of the generated LUT and holds the count value. Then, the LUT generation unit 204 derives the offset (rowOffset) of each row of the LUT. Furthermore, the LUT generation unit 204 performs the calculation illustrated in FIG. 12 using the offset of each row and the number of points in the row, derives DstIdx, and updates the LUT (FIG. 11B). That is, the first identification information may include the offset of a second partial area including a valid point within the first partial area and a second identification information for identifying the valid point within the second partial area. The LUT generation unit 204 supplies the updated LUT and the derived block offset to the 3D reconstruction unit 205.

The 3D reconstruction unit 205 acquires the geometry video frame, attribute video frame, and occupancy map supplied from the 2D decoding unit 202. The 3D reconstruction unit 205 acquires the atlas information supplied from the atlas information decoding unit 203. Furthermore, the 3D reconstruction unit 205 acquires the LUT and the block offset supplied from the LUT generation unit 204.

The 3D reconstruction unit 205 converts 2D data into 3D data using the acquired information, and reconstructs the point cloud data. In addition, the 3D reconstruction unit 205 controls writing of decoding results of valid points of the reconstructed point cloud to the storage unit 206 using the acquired information. For example, the 3D reconstruction unit 205 adds DstIdx indicated by the LUT and the block offset to specify a small area for storing the decoding result (derive its address). That is, the position of the small area corresponding to the valid point in the storage area may be indicated using the offset of the first partial area including the valid point and the first identification information for identifying the valid point in the first partial area.

The 3D reconstruction unit 205 stores (writes) geometry and attribute data of valid points of the reconstructed point cloud in the derived address of the storage area of the storage unit 206. That is, the 3D reconstruction unit 205 uses table information that associates each of the plurality of valid points of the point cloud with each of the plurality of successive small areas in the storage area to store the geometry data and the attribute data of the plurality of valid points generated from the video frames generated by the 2D decoding unit 202 in a small area of the storage area, associated with the valid point in the table information.

The storage unit 206 has a predetermined storage area, and stores the decoding result supplied under such control in the storage area. The storage unit 206 can also supply the stored information such as the decoding results to the rendering unit 207.

The rendering unit 207 appropriately reads and renders the point cloud data stored in the storage unit 206 to generate a display image. The rendering unit 207 outputs the display image to, for example, a monitor or the like.

Note that the demultiplexing unit 201 to the storage unit 206 can be configured as a software library 221, as indicated by the dotted frame. The storage unit 206 and the rendering unit 207 can function as an application 222.

With the above-described configuration, the decoding device 200 can store the decoding results of valid points in successive small areas of the storage area. As a result, it is possible to suppress a decrease in access speed to the decoding result stored in the storage area.

<Flow of Decoding Processing>

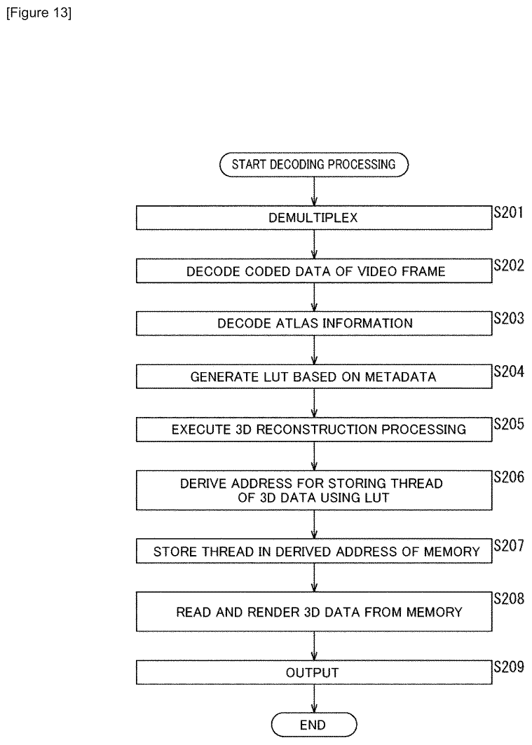

An example of a flow of decoding processing executed by such a decoding device 200 will be described with reference to the flowchart in FIG. 13.

When the decoding processing is started, the demultiplexing unit 201 of the decoding device 200 demultiplexes the bitstream in step S201.

In step S202, the 2D decoding unit 202 decodes the coded data of the video frame. For example, the 2D decoding unit 202 decodes the coded data of the geometry video frame to generate the geometry video frame. The 2D decoding unit 202 decodes the coded data of the attribute video frame to generate the attribute video frame.

In step S203, the atlas information decoding unit 203 decodes the atlas information.

In step S204, the LUT generation unit 204 generates a LUT based on the metadata.

In step S205, the 3D reconstruction unit 205 executes 3D reconstruction processing.

In step S206, the 3D reconstruction unit 205 uses the LUT to derive an address for storing the 3D data thread.

In step S207, the 3D reconstruction unit 205 stores the thread in the derived address of the memory. At that time, the 3D reconstruction unit 205 uses table information that associates each of the plurality of valid points in the point cloud with each of the plurality of successive small areas in the storage area to store the geometry data and the attribute data of the plurality of valid points generated from the generated video frames in a small area of the storage area, associated with the valid point in the table information.

In step S208, the rendering unit 207 reads and renders the 3D data from the memory to generate a display image.

In step S209, the rendering unit 207 outputs the display image. When the processing of step S209 ends, the decoding processing ends.

By executing the processing of each step in this manner, the decoding device 200 can store the decoding results of valid points in successive small areas of the storage area. As a result, it is possible to suppress a decrease in access speed to the decoding result stored in the storage area.

### 4. Third Embodiment

<Coding Device>

In the above description, the metadata is generated in the coding device 100 and the LUT is generated in the decoding device 200. However, the present invention is not limited to this, and, for example, the LUT may be generated in the coding device 100 and provided to the decoding device 200.

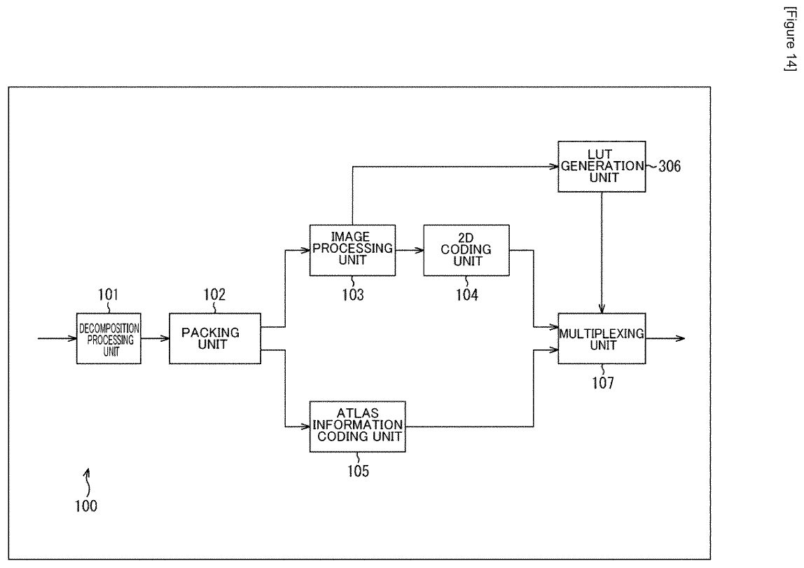

A block diagram of FIG. 14 illustrates an example of major components of the coding device 100 in that case. As illustrated in FIG. 14, the coding device 100 in this case has a LUT generation unit 306 instead of the metadata generation unit 106 (FIG. 6).

The LUT generation unit 306 acquires the occupancy map supplied from the image processing unit 103. Based on the occupancy map, the LUT generation unit 306 generates table information (LUT) that associates each of the plurality of valid points of the point cloud with each of a plurality of successive small areas in the storage area instead of the metadata. The LUT generation unit 306 supplies the generated LUT to the multiplexing unit 107.

In this case, the multiplexing unit 107 multiplexes the coded data generated by the 2D coding unit 104 and the LUT generated by the LUT generation unit 306 to generate a bitstream. In this case, the multiplexing unit 107 outputs a bitstream including the LUT.

<Flow of Coding Processing>

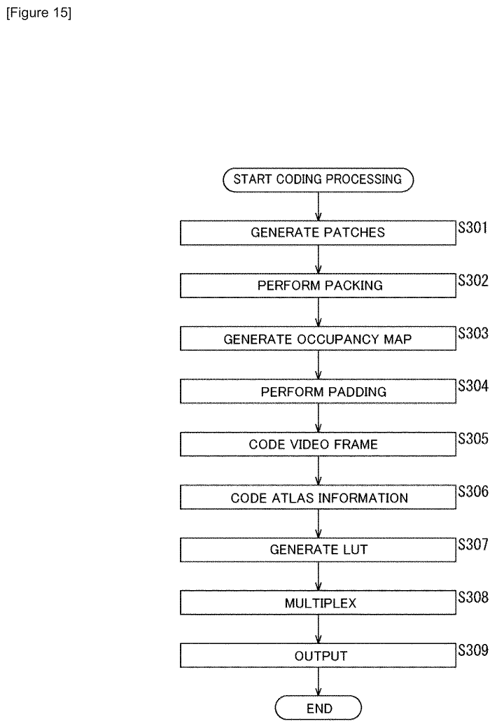

An example of the flow of coding processing in this case will be described with reference to the flowchart of FIG. 15. In this case, the processing of steps S301 to S306 is executed in the same manner as the processing of steps S101 to S106 in FIG. 8.

However, in step S307, the LUT generation unit 306 generates a LUT that associates each of the plurality of valid points of the point cloud with each of the plurality of successive small areas in the storage area.

Processing of steps S308 and S309 is executed in the same manner as the processing of steps S108 and S109 of FIG. 8. When the processing of step S309 ends, the coding processing ends.

By executing the processing of each step in this way, the coding device 100 can supply the LUT to the decoding-side device. As a result, the decoding-side device can store the decoding results of valid points in successive small areas of the storage area based on the LUT. As a result, it is possible to suppress a decrease in access speed to the decoding result stored in the storage area.

<Decoding Device>

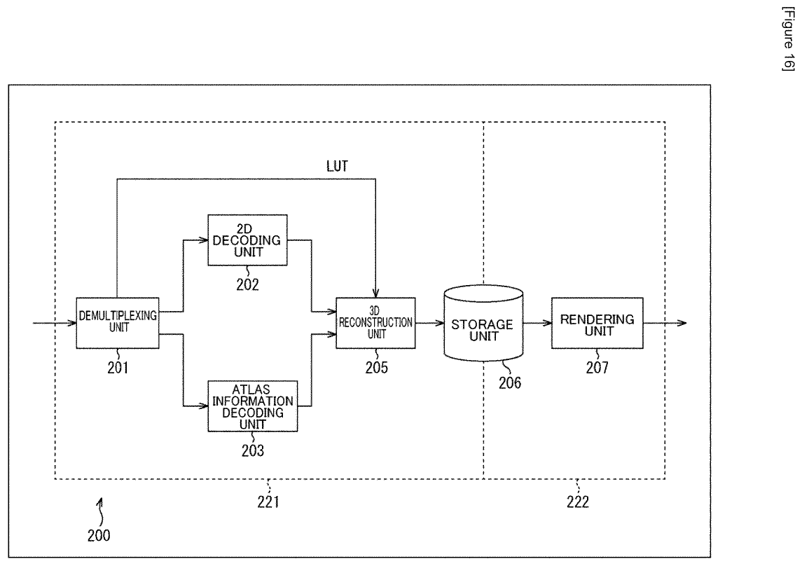

FIG. 16 illustrates an example of major components of the decoding device 200 in this case. As illustrated in FIG. 16, the decoding device 200 in this case does not include the LUT generation unit 204 compared to the case of FIG. 9.

Then, the demultiplexing unit 201 extracts the LUT included in the bitstream by demultiplexing the bitstream and supplies it to the 3D reconstruction unit 205. Based on the LUT, the 3D reconstruction unit 205 can control writing to the storage unit 206 as in the case of FIG. 9.

<Flow of Decoding Processing>

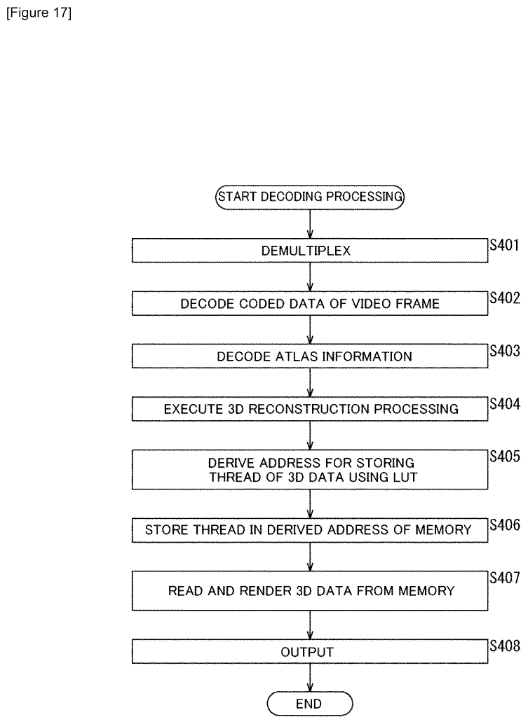

FIG. 17 illustrates an example of the flow of decoding processing in this case. Processing of steps S401 to S408 in this case is executed in the same manner as processing of steps S201 to S203 and steps S205 to S209 in FIG. 13.

By executing the processing of each step in this manner, the decoding device 200 can use the LUT supplied from the coding-side device to store the decoding results of valid points in successive small areas of the storage area. As a result, it is possible to suppress a decrease in access speed to the decoding result stored in the storage area.

### 5. Fourth Embodiment

<Coding Device>

Conversely, the coding device 100 may generate neither metadata nor LUT, and the decoding device 200 may not generate the LUT based on the decoding result.

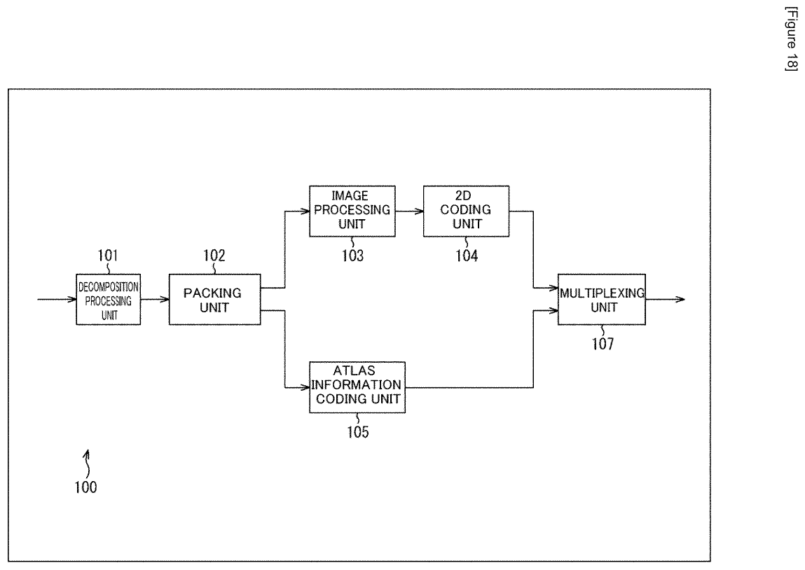

FIG. 18 illustrates an example of major components of the coding device 100 in that case. As illustrated in FIG. 18, the coding device 100 in this case does not include the metadata generation unit 106 compared to the example of FIG. 6. The coding device 100 in this case does not include the LUT generation unit 306 compared to the example of FIG. 14. Therefore, the coding device 100 in this case outputs neither metadata nor LUT.

<Flow of Coding Processing>

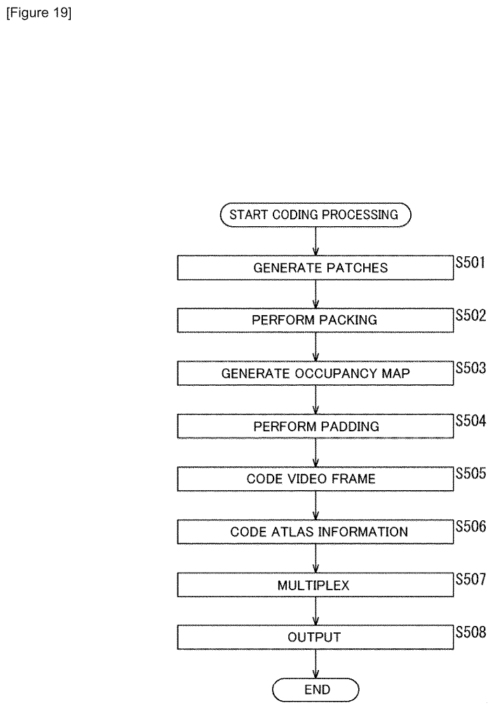

FIG. 19 illustrates an example of the flow of coding processing in that case. In this case, processing of steps S501 to S508 are executed in the same manner as processing of steps S301 to S306 and steps S308 and S309 in FIG. 15.

<Decoding Device>

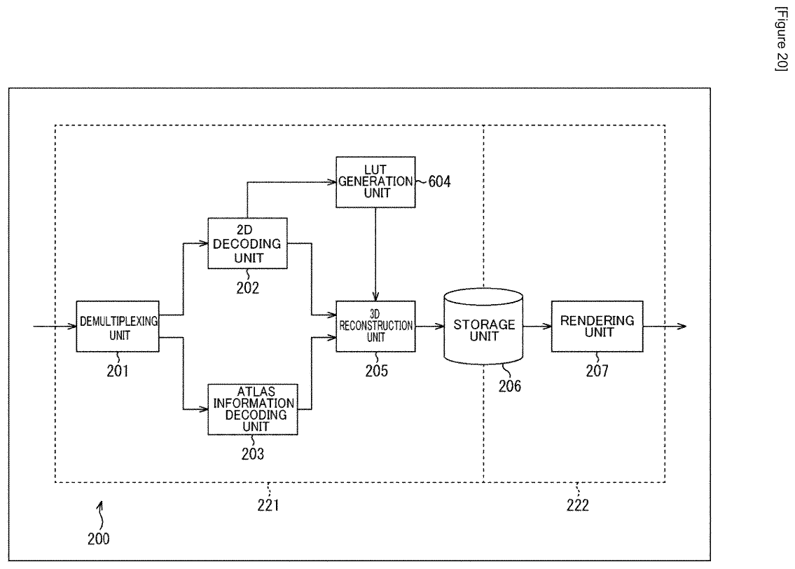

FIG. 20 illustrates an example of major components of the decoding device 200 corresponding to the coding device 100 in this case. As illustrated in FIG. 20, the decoding device 200 in this case has a LUT generation unit 604 instead of the LUT generation unit 204 compared to the example of FIG. 9.

The LUT generation unit 604 acquires the occupancy map (decoding result) supplied from the 2D decoding unit 202. The LUT generation unit 604 uses the occupancy map to generate a LUT and supplies it to the 3D reconstruction unit 205. That is, the LUT generation unit 604 derives the number of valid points for each of the first partial areas using the video frame (occupancy map) generated by the 2D decoding unit 202, and derives the offset of the first partial areas based on the derived number of valid points for each of the first partial areas.

<Flow of Decoding Processing>

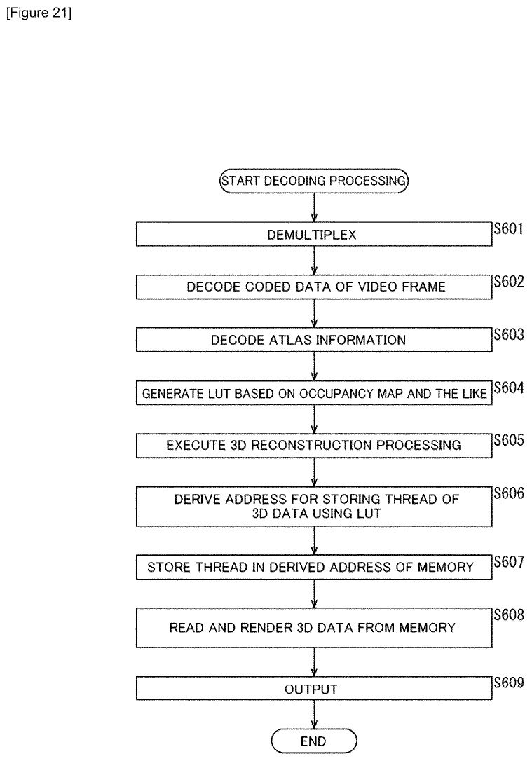

FIG. 21 illustrates an example of the flow of decoding processing in this case. Processing of steps S601 to S603 in this case is executed in the same manner as processing of steps S201 to S203 in FIG. 13.

In step S604, the LUT generation unit 604 generates a LUT based on the occupancy map.

Processing of steps S605 to S609 is executed in the same manner as processing of steps S204 to S209.

By executing the processing of each step in this way, the decoding device 200 can derive a LUT based on the decoding result and use the LUT to store the decoding results of valid points in successive small areas of the storage area. As a result, it is possible to suppress a decrease in access speed to the decoding result stored in the storage area. In this case, since transmission of LUT and metadata is not omitted, reduction in coding efficiency can be suppressed.

### 6. Application Example

The decoding device 200 described above can be implemented in, for example, a central processing unit (CPU) or a GPU. The coding device 100 can be implemented in a CPU.

For example, in the case of the third embodiment, the coding device 100 may be implemented in a CPU, and the LUT may be generated in the CPU. In the case of the fourth embodiment, the coding device 100 may be implemented in a CPU, the decoding device 200 may also be implemented in a CPU, and the LUT may be generated in the CPU.

Furthermore, in the first embodiment, the coding device 100 may be implemented in a CPU, the metadata may be generated in the CPU, the decoding device 200 may be implemented in the GPU, and the LUT may be generated in the GPU.

Moreover, in the fourth embodiment, the decoding device 200 may be implemented in a CPU and a GPU, the metadata may be generated in the CPU, and the LUT may be generated in the GPU.

### 7. Supplement

<Computer>

The above-described series of processing can be executed by hardware or software. In the case where the series of processes are executed by software, a program that configures the software is installed on a computer. Here, the computer includes, for example, a computer built in dedicated hardware and a general-purpose personal computer on which various programs are installed to be able to execute various functions.

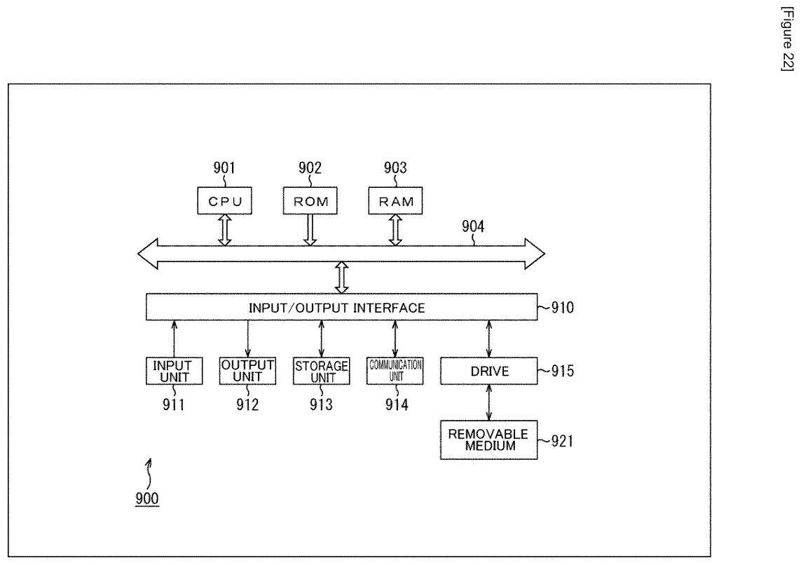

FIG. 22 is a block diagram illustrating an example of a hardware configuration of a computer that executes the above-described series of processing according to a program.

In a computer 900 illustrated in FIG. 22, a central processing unit (CPU) 901, a read only memory (ROM) 902, and a random access memory (RAM) 903 are connected to each other via a bus 904.

An input/output interface 910 is also connected to the bus 904. An input unit 911, an output unit 912, a storage unit 913, a communication unit 914, and a drive 915 are connected to the input/output interface 910.

The input unit 911 is, for example, a keyboard, a mouse, a microphone, a touch panel, or an input terminal. The output unit 912 is, for example, a display, a speaker, or an output terminal. The storage unit 913 includes, for example, a hard disk, a RAM disk, or a non-volatile memory. The communication unit 914 includes, for example, a network interface. The drive 915 drives a removable medium 921 such as a magnetic disk, an optical disc, a magneto-optical disk, or a semiconductor memory.

In the computer having the above-described configuration, the CPU 901 performs the aforementioned series of processes by loading a program stored in the storage unit 913 to the RAM 903 via the input/output interface 910 and the bus 904 and executing the program, for example. The RAM 903 also appropriately stores data and the like necessary for the CPU 901 to execute various kinds of processing.

The program executed by the computer can be recorded in, for example, the removable medium 921 as a package medium or the like and provided in such a form. In such a case, the program can be installed in the storage unit 913 via the input/output interface 910 by inserting the removable medium 921 into the drive 915.

This program can also be provided via wired or wireless transfer medium such as a local area network, the Internet, and digital satellite broadcasting. In such a case, the program can be received by the communication unit 914 and installed in the storage unit 913.

In addition, this program may be installed in advance in the ROM 902 or the storage unit 913.

<Application Target of Present Technology>

Although cases in which the present technology is applied to coding/decoding of point cloud data have been described above, the present technology is not limited to such examples and can be applied to coding/decoding of 3D data in any standard. That is, various types of processing such as coding/decoding methods, and specifications of various types of data such as 3D data and metadata may be arbitrary as long as they does not contradict the above-described present technology. In addition, the above-described some processing and specifications may be omitted as long as it does not contradict the present technology.

Moreover, although the coding device 100, the decoding device 200, and the like have been described above as examples to which the present technology is applied, the present technology can be applied to any configuration.

For example, the present technology can be applied to various electronic devices such as a transmitter or a receiver (for example, a television receiver or a mobile phone) in wired broadcasting of a satellite broadcasting, a cable TV, or the like, transmission on the Internet, or delivery to a terminal through cellular communication, or a device (for example, a hard disk recorder or a camera) recording an image on a medium such as an optical disc, a magnetic disk, and a flash memory or reproducing an image from the storage medium.

For example, the present technology can be implemented as a configuration of a part of a device such as a processor (for example, a video processor) of a system large scale integration (LSI), a module (for example, a video module) using a plurality of processors or the like, a unit (for example, a video unit) using a plurality of modules or the like, or a set (for example, a video set) with other functions added to the unit.

The present technology can also be applied to a network system configured of a plurality of devices, for example. The present technology may be performed by cloud computing in which it is assigned to and processed together by a plurality of devices via a network, for example. For example, the present technology may be performed in a cloud service that provides services regarding images (moving images) to arbitrary terminals such as a computer, an audio visual (AV) device, a mobile information processing terminal, an Internet-of-Things (IoT) device, and the like.

In the present specification, a system means a set of a plurality of constituent elements (devices, modules (parts), or the like) and all the constituent elements may not be in the same casing. Accordingly, a plurality of devices accommodated in separate casings and connected via a network and a single device accommodating a plurality of modules in a single casing are all a system.

<Fields and Applications to which Present Technology is Applicable>

A system, device, a processing unit, and the like to which the present technology is applied can be used in any field such as traffic, medical treatment, security, agriculture, livestock industries, a mining industry, beauty, factories, home appliance, weather, and natural surveillance, for example. Any purpose can be set.

<Others>

Note that the “flag” in the present specification is information for identifying a plurality of states and includes not only information used to identify two states, namely true (1) or false (0), but also information with which three or more states can be identified. Therefore, values that the “flag” can take may be, for example, two values of 1 and 0 or three or more values. In other words, the number of bits constituting the “flag” may be an arbitrary number and may be 1 bit or a plurality of bits. Since not only the form in which the identification information is included in a bitstream but also the form in which difference information of identification information with respect to certain reference information is included in a bitstream can be assumed as the identification information (including the flag), the “flag” and the “identification information” in the present specification include not only the information itself but also the difference information with respect to the reference information.

Various kinds of information (such as metadata) related to coded data (bitstream) may be transmitted or recorded in any form as long as it is associated with the coded data. Here, the term “associated” means that when one data is processed, the other may be used (may be associated), for example. In other words, mutually associated items of data may be integrated as one item of data or may be individual items of data. For example, information associated with coded data (image) may be transmitted through a transmission path that is different from that for the coded data (image). The information associated with the coded data (image) may be recorded in a recording medium that is different from that for the coded data (image) (or a different recording area in the same recording medium), for example. Meanwhile, this “association” may be for part of data, not the entire data. For example, an image and information corresponding to the image may be associated with a plurality of frames, one frame, or any unit such as a part in the frame.

Meanwhile, in the present specification, terms such as “synthesize”, “multiplex”, “add”, “integrate”, “include”, “store”, “put in”, “enclose”, and “insert” may mean, for example, combining a plurality of objects into one, such as combining coded data and metadata into one piece of data, and means one method of “associating” described above.

Embodiments of the present technology are not limited to the above-described embodiments and can be changed variously within the scope of the present technology without departing from the gist of the present technology.

For example, a configuration described as one device (or processing unit) may be split into and configured as a plurality of devices (or processing units). Conversely, configurations described above as a plurality of devices (or processing units) may be integrated and configured as one device (or processing unit). It is a matter of course that configurations other than the aforementioned configurations may be added to the configuration of each device (or each processing unit). Moreover, some of configurations of a certain device (or processing unit) may be included in a configuration of another device (or another processing unit) as long as configurations and operations of the entire system are substantially the same.

The aforementioned program may be executed by an arbitrary device, for example. In that case, it is only necessary for the device to have necessary functions (such as functional blocks) such that the device can obtain necessary information.

For example, each step of one flowchart may be executed by one device, or may be shared and executed by a plurality of devices. When a plurality of processing are included in one step, one device may execute the plurality of processing, or the plurality of devices may share and execute the plurality of processing. In other words, it is also possible to execute the plurality of processing included in one step as processing of a plurality of steps. On the other hand, it is also possible to execute processing described as a plurality of steps collectively as one step.

For example, in a program that is executed by a computer, processing of steps describing the program may be executed in time series in an order described in the present specification, or may be executed in parallel or individually at a required timing such as when call is made. That is, the processing of the respective steps may be executed in an order different from the above-described order as long as there is no contradiction. The processing of the steps describing this program may be executed in parallel with processing of another program, or may be executed in combination with the processing of the other program.

For example, a plurality of technologies regarding the present technology can be independently implemented as a single body as long as there is no contradiction. Of course, it is also possible to perform any plurality of the present technologies in combination. For example, it is also possible to implement some or all of the present technologies described in any of the embodiments in combination with some or all of the technologies described in other embodiments. Further, it is also possible to implement some or all of any of the above-described technologies in combination with other technologies not described above.

The present technology can also be configured as follows.

(1) An image processing device comprising:
a video frame decoding unit that decodes coded data to generate a video frame including geometry data projected onto a two-dimensional plane and a video frame including attribute data projected onto a two-dimensional plane, of a point cloud expressing a three-dimensional object as a set of points; and
a control unit that uses table information associating each of a plurality of valid points of the point cloud with each of a plurality of successive small areas in a storage area to store the geometry data and the attribute data of the plurality of valid points generated from the video frames generated by the video frame decoding unit in the small area of the storage area, associated with the valid point in the table information.

(2) The image processing device according to (1), further comprising
a table information generation unit that generates the table information.

(3) The image processing device according to (2), wherein
the table information generation unit generates the table information for each of the first partial areas.

(4) The image processing device according to (3), wherein
the table information indicates a position of the small area corresponding to the valid point in the storage area using an offset of the first partial area including the valid point and first identification information for identifying the valid point in the first partial area.

(5) The image processing device according to (4), wherein
the first identification information includes an offset of a second partial area including the valid point within the first partial area and second identification information for identifying the valid point in the second partial area.

(6) The image processing device according to (4) or (5), further comprising:
a metadata acquisition unit that acquires metadata including information about the number of valid points, wherein
the table information generation unit generates the table information using the metadata acquired by the metadata acquisition unit.

(7) The image processing device according to (6), wherein
the table information generation unit derives the offset of the first partial area based on information indicating the number of valid points for each of the first partial areas, which is included in the metadata.

(8) The image processing device according to any one of (4) to (7), wherein
the table information generation unit generates the table information using the video frames generated by the video frame decoding unit.

(9) The image processing device according to (8), wherein
the table information generation unit derives the number of valid points for each of the first partial areas using the video frames generated by the video frame decoding unit and derives the offset of the first partial area based on the derived number of valid points for each of the first partial areas.

(10) The image processing device according to any one of (1) to (9), further comprising:
a table information acquisition unit that acquires the table information, wherein the control unit uses the table information acquired by the table information acquisition unit to store the geometry data and the attribute data of the plurality of valid points generated from the video frame generated by the video frame decoding unit in the small area of the storage area, associated with the valid point in the table information.

(11) The image processing device according to any one of (1) to (10), further comprising:
a reconstruction unit that reconstructs the point cloud using the video frames generated by the video frame decoding unit, wherein
the control unit stores the geometry data and the attribute data of the plurality of valid points of the point cloud reconstructed by the reconstruction unit in the small area of the storage area, associated with the valid point in the table information.

(12) The image processing device according to any one of (1) to (11), further comprising:
a storage unit having the storage area.

(13) An image processing method comprising:
decoding coded data to generate a video frame including geometry data projected onto a two-dimensional plane and a video frame including attribute data projected onto a two-dimensional plane, of a point cloud expressing a three-dimensional object as a set of points; and
using table information associating each of a plurality of valid points of the point cloud with each of a plurality of successive small areas in a storage area, storing the geometry data and the attribute data of the plurality of valid points generated from the generated video frames in the small area of the storage area, associated with the valid point in the table information.

(14) An image processing device comprising:
a video frame coding unit that codes a video frame including geometry data projected onto a two-dimensional plane and a video frame including attribute data projected onto a two-dimensional plane, of a point cloud expressing a three-dimensional object as a set of points to generate coded data;
a generation unit that generates metadata including information about the number of valid points of the point cloud; and
a multiplexing unit that multiplexes the coded data generated by the video frame coding unit and the metadata generated by the generation unit.

(15) The image processing device according to (14), wherein
the generation unit generates the metadata indicating the number of valid points for each of the first partial areas.

(16) The image processing device according to (15), wherein
the generation unit derives the number of valid points for each of the first partial areas based on the video frames coded by the video frame coding unit and generates the metadata.

(17) The image processing device according to (16), wherein
the generation unit derives the number of valid points for each of the first partial areas based on an occupancy map corresponding to the geometry data and generates the metadata.

(18) The image processing device according to any one of (14) to (17), wherein the generation unit losslessly codes the generated metadata, and
the multiplexing unit multiplexes the coded data generated by the video frame coding unit and the coded data of the metadata generated by the generation unit.

(19) The image processing device according to any one of (14) to (18), wherein
the generation unit generates table information that associates each of the plurality of valid points of the point cloud with each of a plurality of successive small areas in a storage area, and
the multiplexing unit multiplexes the coded data generated by the video frame coding unit and the table information generated by the generation unit.

(20) An image processing method comprising:
coding a video frame including geometry data projected onto a two-dimensional plane and a video frame including attribute data projected onto a two-dimensional plane, of a point cloud expressing a three-dimensional object as a set of points to generate coded data;
generating metadata including information about the number of valid points of the point cloud; and
multiplexing the generated coded data and metadata.

### REFERENCE SIGNS LIST

100 Coding device
101 Decomposition processing unit
102 Packing unit
103 Image processing unit
104 2D coding unit
105 Atlas information coding unit
106 Metadata generation unit
107 Multiplexing unit
200 Decoding device
201 Demultiplexing unit
202 2D decoding unit
203 Atlas information decoding unit
204 LUT generation unit
604 LUT generation unit

1. An image processing device comprising:
a video frame decoding unit that decodes coded data to generate a video frame including geometry data projected onto a two-dimensional plane and a video frame including attribute data projected onto a two-dimensional plane, of a point cloud expressing a three-dimensional object as a set of points; and
a control unit that uses table information associating each of a plurality of valid points of the point cloud with each of a plurality of successive small areas in a storage area to store the geometry data and the attribute data of the plurality of valid points generated from the video frames generated by the video frame decoding unit in the small area of the storage area, associated with the valid point in the table information.

2. The image processing device according to claim 1, further comprising a table information generation unit that generates the table information.

3. The image processing device according to claim 2, wherein
the table information generation unit generates the table information for each of the first partial areas.

4. The image processing device according to claim 3, wherein
the table information indicates a position of the small area corresponding to the valid point in the storage area using an offset of the first partial area including the valid point and first identification information for identifying the valid point in the first partial area.

5. The image processing device according to claim 4, wherein
the first identification information includes an offset of a second partial area including the valid point within the first partial area and second identification information for identifying the valid point in the second partial area.

6. The image processing device according to claim 4, further comprising:
a metadata acquisition unit that acquires metadata including information about the number of valid points, wherein
the table information generation unit generates the table information using the metadata acquired by the metadata acquisition unit.

7. The image processing device according to claim 6, wherein
the table information generation unit derives the offset of the first partial area based on information indicating the number of valid points for each of the first partial areas, which is included in the metadata.

8. The image processing device according to claim 4, wherein
the table information generation unit generates the table information using the video frames generated by the video frame decoding unit.

9. The image processing device according to claim 8, wherein
the table information generation unit derives the number of valid points for each of the first partial areas using the video frames generated by the video frame decoding unit and derives the offset of the first partial area based on the derived number of valid points for each of the first partial areas.

10. The image processing device according to claim 1, further comprising:
a table information acquisition unit that acquires the table information, wherein the control unit uses the table information acquired by the table information acquisition unit to store the geometry data and the attribute data of the plurality of valid points generated from the video frame generated by the video frame decoding unit in the small area of the storage area, associated with the valid point in the table information.

11. The image processing device according to claim 1, further comprising:
a reconstruction unit that reconstructs the point cloud using the video frames generated by the video frame decoding unit, wherein
the control unit stores the geometry data and the attribute data of the plurality of valid points of the point cloud reconstructed by the reconstruction unit in the small area of the storage area, associated with the valid point in the table information.

12. The image processing device according to claim 1, further comprising:
a storage unit having the storage area.

13. An image processing method comprising:
decoding coded data to generate a video frame including geometry data projected onto a two-dimensional plane and a video frame including attribute data projected onto a two-dimensional plane, of a point cloud expressing a three-dimensional object as a set of points; and
using table information associating each of a plurality of valid points of the point cloud with each of a plurality of successive small areas in a storage area, storing the geometry data and the attribute data of the plurality of valid points generated from the generated video frames in the small area of the storage area, associated with the valid point in the table information.

14. An image processing device comprising:
a video frame coding unit that codes a video frame including geometry data projected onto a two-dimensional plane and a video frame including attribute data projected onto a two-dimensional plane, of a point cloud expressing a three-dimensional object as a set of points to generate coded data;
a generation unit that generates metadata including information about the number of valid points of the point cloud; and
a multiplexing unit that multiplexes the coded data generated by the video frame coding unit and the metadata generated by the generation unit.

15. The image processing device according to claim 14, wherein
the generation unit generates the metadata indicating the number of valid points for each of the first partial areas.

16. The image processing device according to claim 15, wherein
the generation unit derives the number of valid points for each of the first partial areas based on the video frames coded by the video frame coding unit and generates the metadata.

17. The image processing device according to claim 16, wherein
the generation unit derives the number of valid points for each of the first partial areas based on an occupancy map corresponding to the geometry data and generates the metadata.

18. The image processing device according to claim 14, wherein
the generation unit losslessly codes the generated metadata, and
the multiplexing unit multiplexes the coded data generated by the video frame coding unit and the coded data of the metadata generated by the generation unit.

19. The image processing device according to claim 14, wherein
the generation unit generates table information that associates each of the plurality of valid points of the point cloud with each of a plurality of successive small areas in a storage area, and
the multiplexing unit multiplexes the coded data generated by the video frame coding unit and the table information generated by the generation unit.

20. An image processing method comprising:
coding a video frame including geometry data projected onto a two-dimensional plane and a video frame including attribute data projected onto a two-dimensional plane, of a point cloud expressing a three-dimensional object as a set of points to generate coded data;
generating metadata including information about the number of valid points of the point cloud; and
multiplexing the generated coded data and metadata.
